(19) United States
(12) Patent Application Publication
(10) Pub. No.: US 2012/0310619 A1
(43) Pub. Date: Dec. 6, 2012

(54) FAST FUNCTION EXTRACTION

(75) Inventor: Trent Lorne McCONAGHY, Vancouver (CA)

(73) Assignee: SOLIDO DESIGN AUTOMATION INC., Saskatoon (CA)

(21) Appl. No.: 13/444,249

(22) Filed: Apr. 11, 2012

Related U.S. Application Data
(60) Provisional application No. 61/493,643, filed on Jun. 6, 2011.

(51) Int. Cl. G06F 17/50

(52) U.S. Cl. 703/14

(57) ABSTRACT

For application to analog, mixed-signal, and custom digital circuits, as well as other fields have use for high-dimensional regression, or symbolic modeling, a system and method to extract functions, where each function relates a set of input variables to an output variable (performance metric). The technique enumerates a large set of candidate basis functions, performs pathwise regularized learning on those basis functions to generate a set of candidate models, and finally performs nondominated filtering to identify models that trade off complexity versus error.

### CROSS REFERENCE TO RELATED APPLICATIONS

This application claims the benefit of priority of U.S. Provisional Patent Application No. 61/493,643 filed Jun. 6, 2011, which is incorporated herein by reference in its entirety.

### FIELD

The present disclosure relates to automatically generating functions that map a set of input variables to an output variable, for use in scientific/engineering analysis and design. More particularly, the present disclosure relates to design tools used to improve the performance and yield of analog, mixed-signal, and custom digital electrical circuit designs (ECDs).

### BACKGROUND

Symbolic models of analog circuits have many applications. Fundamentally, they increase a designer's understanding of a circuit, which leads to better decision making in circuit sizing, layout, verification, and topology design. Automated approaches to symbolic model generation are therefore of great interest.

In symbolic analysis, models are derived via topology analysis, a survey of which is found in G. E. Gielen, “Techniques and Applications of Symbolic Analysis for Analog Integrated Circuits: A Tutorial Overview”, in Computer Aided Design of Analog Integrated Circuits And Systems, R. A. Rutenbar et al., eds., IEEE, 2002, pp. 245-261. The main weakness of symbolic analysis is that it is limited to linear and weakly nonlinear circuits.

Leveraging simulations from a Simulation Program with Integrated Circuit Emphasis (SPICE), in circuit modeling, can be useful because simulators readily handle nonlinear circuits, as well as environmental effects, manufacturing effects, and different technologies. Simulation data has been used to train neural networks as shown in: P. Vancorenland, G. Van der Plas, M. Steyaert, G. Gielen, W. Sansen, “A Layout-aware Synthesis Methodology for RF Circuits,” Proc. ICCAD 01, November 2001, p. 358; H. Liu, A. Singhee, R. A. Rutenbar, L. R. Carley, “Remembrance of Circuits Past: Macromodeling by Data Mining in Large Analog Design Spaces,” Proc. DAC 02, June 2002, pp. 437-442′; and G. Wolfe, R. Vemuri, “Extraction and Use of Neural Network Models in Automated Synthesis of Operational Amplifiers.” IEEE Trans. CAD, February 2003. However, such modeling provide no insight to the designer.

The aim of symbolic modeling is to use simulation data to generate interpretable mathematical expressions that relate the circuit performances to the design variables. In W. Daems, G. Gielen, and W. Sansen, “An Efficient Optimization-based Technique to Generate Posynomial Performance Models for Analog Integrated Circuits”, Proc. DAC 02, June 2002; and W. Daems, G. Gielen, W. Sansen, “Simulation-based generation of posynomial performance models for the sizing of analog integrated circuits,” IEEE Trans. CAD 22(5), May 2003, pp. 517-534, symbolic models are built from a posynomial (positive polynomial) template. The main problem in this approach is that the models are constrained to a template, which restricts the functional form and in doing so also imposes bias. Also, the models have dozens of terms, limiting their interpretability (i.e., the insight they provide is often limited). Finally, the approach assumes posynomials can fit the data; in circuits, there is no guarantee of this, and one might never know in advance.

On the other end of the spectrum are approaches that generate more open-ended models. Traditional genetic programming (GP) (e.g., see John R. Koza. Genetic Programming. MIT Press, 1992) uses a population-based search to traverse a set of possible tree expressions, where each tree expression represents a function. Unfortunately, the returned functions are overly complex. A variant called CAFFEINE (T. McConaghy, T. Eeckelaert, G. G. E. Gielen, CAFFEINE: template-free symbolic model generation of analog circuits via canonical form functions and genetic programming, in Proc. Design Automation and Test in Europe (DATE), pp. 1070-1075, Mar. 7-11, 2005) uses a special grammar to restrict the search space to functions that are easier for humans to interpret. These approaches have other drawbacks: they are time-consuming for larger problems; they return models with high prediction error when there is high input dimensionality and fewer samples; and they are stochastic, which means they can return very different results from run to run, and convergence is hard to predict.

Therefore improvements in symbolic modeling of electrical circuit designs are desirable.

### SUMMARY

In a first aspect, the present disclosure provides a tangible, non-transitory computer-readable medium having stored thereon instructions to be carried out by a computer to perform a method to model a performance metric of a system as a function of variables of the system. The method comprises: in accordance with a set of sample points of a space defined by the variables of the system, calculating a value of the performance metric for each point of the set of sample points, the values of the performance metric defining performance data; in accordance with the set of sample points and in accordance with the performance data, performing, on a set of basis functions, each basis function having associated thereto a weight factor, a pathwise regularized linear regression algorithm having associated thereto a regularization term, to obtain multiple models of the performance metric of the system at respective multiple values of the regularization term, each model having a set of weight factors values, each value of the regularization term having associated thereto a single model of the performance metric; for a plurality of regularization term values, calculating an error value and a complexity value of a corresponding model of the performance metric; and for the plurality of regularization term values, performing a non-dominated filtering of the models corresponding to the plurality of regularization term values, the non-dominated filtering being performed in accordance with the error value and the complexity value of each model, the non-dominated filtering to obtain non-dominated models of the performance metric.

In a second aspect, the present disclosure provides a tangible, non-transitory computer-readable medium having stored thereon instructions to be carried out by a computer to perform a method to model a performance metric of a system as a function of variables of the system. The method comprises: in accordance with a set of sample points of a space defined by the variables of the system, calculating a value of the performance metric for each point of the set of sample points, the values of the performance metric defining performance data; generating a first set of basis functions consisting of univariate basis functions; in accordance with the set of sample points and in accordance with the performance data, performing, on the set of univariate basis functions, each univariate basis function having associated thereto a weight factor, a pathwise regularized linear regression algorithm having associated thereto a first regularization term, to obtain multiple models of the performance metric of the system at multiple values of the first regularization term, each model having a respective set of weight factors values, each value of the first regularization term having associated thereto a single model of the performance metric; identifying a model having a lowest test error to obtain an identified model; identifying the univariate basis functions of the identified model that have the highest impacts, to obtain identified univariate basis functions; in accordance with the identified univariate basis functions, generating a set of bivariate basis functions; generating a union set of basis functions comprising the identified univariate basis functions and the set of bivariate basis functions; in accordance with the first set of sample points and in accordance with the performance data, performing, on the union set of basis functions, each basis function having associated thereto a weight factor, a pathwise regularized linear regression algorithm having associated thereto a second regularization term, to obtain multiple models of the performance metric of the system at multiple values of the second regularization term, each model having a respective set of weight factors values, each value of the second regularization term having associated thereto a single model of the performance metric; and for a plurality of second regularization term values, calculating an error value of a corresponding model of the performance metric.

In a third aspect, the present disclosure provides a tangible, non-transitory computer-readable medium having stored thereon instructions to be carried out by a computer to perform a method to model a performance metric of a system as a function of variables of the system. The method comprises: in accordance with a set of sample points of a space defined by the variables of the system, calculating a value of the performance metric for each point of the set of sample points, the values of the performance metric defining performance data; generating a first set of basis functions consisting of univariate basis functions; in accordance with the set of sample points and in accordance with the performance data, performing, on the set of univariate basis functions, each univariate basis function having associated thereto a weight factor, a pathwise regularized linear regression algorithm having associated thereto a first regularization term, to obtain multiple models of the performance metric of the system at multiple values of the first regularization term, each model having a respective set of weight factors values, each value of the first regularization term having associated thereto a single model of the performance metric; identifying a model having a lowest test error to obtain an identified model; identifying the univariate basis functions of the identified model that have the highest impacts to obtain identified univariate basis functions; in accordance with the identified univariate basis functions, generating a set of bivariate basis functions; generating a union set of basis functions comprising the identified univariate basis functions and the set of bivariate basis functions; in accordance with the first set of sample points and in accordance with the performance data, performing, on the union set of basis functions, each basis function having associated thereto a weight factor, a pathwise regularized linear regression algorithm having associated thereto a second regularization term, to obtain multiple models of the performance metric of the system at multiple values of the second regularization term, each model having a respective set of weight factors values, each value of the second regularization term having associated thereto a single model of the performance metric; for a plurality of second regularization term values, calculating an error value and a complexity value of a corresponding model of the performance metric; and for the plurality of second regularization term values, performing a non-dominated filtering of the models corresponding to the plurality of second regularization term values, the non-dominated filtering being performed in accordance with the error value and the complexity value of each model, the non-dominated filtering to obtain non-dominated models of the performance metric.

Other aspects and features of the present disclosure will become apparent to those ordinarily skilled in the art upon review of the following description of specific embodiments of the disclosure in conjunction with the accompanying figures.

### BRIEF DESCRIPTION OF THE DRAWINGS

Embodiments of the present disclosure will now be described, by way of example only, with reference to the attached drawings, wherein:

FIG. 1A shows an example of a plot of weight coefficients as a function of a regularization parameter for the regularization parameter having a value of 10⁴⁰.

FIG. 1B shows an example of a plot of weight coefficients as a function of the regularization parameter for the regularization parameter reaching a value of 10³⁰.

FIG. 1C shows an example of a plot of weight coefficients as a function of the regularization parameter for the regularization parameter reaching a value of 10²⁰.

FIG. 1D shows an example of a plot of weight coefficients as a function of the regularization parameter for the regularization parameter reaching a value of 10¹⁰.

FIG. 1E shows an example of a plot of weight coefficients as a function of the regularization parameter for the regularization parameter reaching a value of 10¹.

FIG. 1F shows an example of a plot of weight coefficients as a function of the regularization parameter for the regularization parameter reaching a value of 10⁻⁵⁰.

FIG. 2 show an embodiment of a flow for a method of the present disclosure.

FIG. 3A shows the same plot as FIG. 1F.

FIG. 3B shows a plot of training error as a function of the regularization parameter of FIG. 3A.

FIG. 3C shows a plot of testing error as a function of the regularization parameter of FIG. 3A.

FIG. 4A shows a plot of model complexity as a function of the regularization parameter of FIG. 3A.

FIG. 4B shows a plot of test error as a function of complexity for models obtained through the exemplary flow of FIG. 2.

FIG. 5A shows the circuit diagram of an operational amplifier used in an example of the present disclosure.

FIG. 5B shows a plot of test error as a function of a number of bases present in a phase margin model of the operational amplifier of FIG. 5A.

FIG. 6 shows an example of a flow for generating univariate basis functions in accordance with the present disclosure.

FIG. 7 shows an example of a flow for generating bivariate basis functions in accordance with the present disclosure.

FIG. 8 shows another an embodiment of a flow for a method of the present disclosure.

### DETAILED DESCRIPTION

Pathwise regularized learning is a known technique that can be used in the present disclosure. The following presents concepts used in pathwise regularized learning.

A known class of functions is that of generalized linear models (J. A. Nelder and R. W. M. Wedderburn, “Generalized linear models”, Journal of the Royal Statistical Society, Vol. 135, 1972, pp. 370-384). A generalized linear model ŷ(x) is a linear combination of N_{B} basis functions Bᵢ*, i={1, 2, . . . , N_{B}}. The generalized linear model ŷ(x) can be written as:

ŷ(x)=wₒ+Σ wᵢ*Bᵢ(x) (equation 1)

where the summation Σ is carried out on all the values of the summation index i. The generalized linear model ŷ(x) is to model data (simulated or measured) represented as y(x), both y(x) and ŷ(x) are functions of data points x, which can have any dimensionality.

Least-squares learning, which is also known, aims to find the values for each coefficient wᵢ (which can also be referred to as weights or weight coefficients) in equation 1, such that that ∥y−X^{T}w∥² is minimized (where the X are the N training input points, each with dimension n, and y are the target training output values). Stated otherwise, least squares fitting aims to find the values of each coefficient wᵢ such that the sum

$${\sum }_{i = 1}^{N} {( {y}_{i} ( x ) - {\hat{y}}_{i} ( x ) )}^{2}$$

is minimized. Therefore, least-squares learning aims to minimize training error; it does not acknowledge testing error (future model prediction error). Because it is singularly focused on training error, least-squares learning may return model coefficients w={w₁, w₂, . . . } where a few coefficients are extremely large, making the model overly sensitive to those coefficients. This scenario can be referred to as an over-fitting scenario.

Regularized learning is known in the art and aims to minimize the model's sensitivity to over-fitted coefficient values, by adding minimization terms that are dependent solely on the coefficients: ∥w∥² or ∥w∥₁=Σ|wᵢ|. This has the implicit effect of minimizing expected future model prediction error (testing error). The overall problem formulation is:

w*=minimize [∥y−X^{T}w∥²+λ₂∥w∥²+λ₁∥w∥₁] (equation 2).

Equation 2 can be written as

$${w}^{*} = Minimize [ {\sum }_{i = 1}^{N} {( {y}_{i} ( x ) - {\hat{y}}_{i} ( x ) )}^{2} + {λ}_{2} {\sum }_{i = 1}^{N} {w}_{i}^{2} + {λ}_{1} {\sum }_{i = 1}^{N} \vert {w}_{i} \vert ] \qquad ( equation 3 )$$

λ₂ and λ₁ are regularization terms (also referred to as regularization parameter or regularization coefficient). It is not required that they both be present. For example, in some embodiments, only λ₂ or λ₁ are used. However, including both regularization terms λ₂ and λ₁ is known as an elastic net formulation of regularized learning (H. Zou and T. Hastie, “Regularization and variable selection via the elastic net,” Journal Of The Royal Statistical Society Series B, Vol. 67, Number 2, 2005, pp. 301-320). The middle term (λ₂∥w∥²—the quadratic term, like ridge regression), encourages correlated variables to group together rather than letting a single variable dominate, and makes convergence more stable. The last term (λ₁∥w∥₁ term, like Lasso), drives towards a sparse model with few coefficients, but discourages any coefficient from being too large. To make the balance between λ₁ and λ₂ explicit, it is possible to set λ₁=λ and λ₂=(1−ρ)*λ, where λ is now the regularization weight, and ρ is a “mixing parameter.”

Looking at equation 3, we see that if λ=0, then the solution reduces to a least-squares solution. Conversely, as λ→∞, then the least-squares term of equation 3 has no effect and only the regularization term matters; and the optimal value of each wᵢ is 0.0.

In pathwise regularized learning, the algorithm sweeps across a set of possible λ values, from λ→∞ (huge λ) to λ=0 (tiny λ). At each λ, equation 3 is solved, to return a w (a set of coefficients wᵢ) at that λ. In doing so, it follows the “path” of solutions going from a regularization-only solution, through combined regularization/least-squares solutions, and finally ends at a least-squares solution. As the pathwise regularized learning progress (as λ decreases), the number of basis functions (number of nonzero coefficients wᵢ) tends to increase, because with smaller λ there is more pressure to explain the training data better, therefore requiring the usage of more nonzero coefficients. The starting wᵢ's are simply set to 0.0.

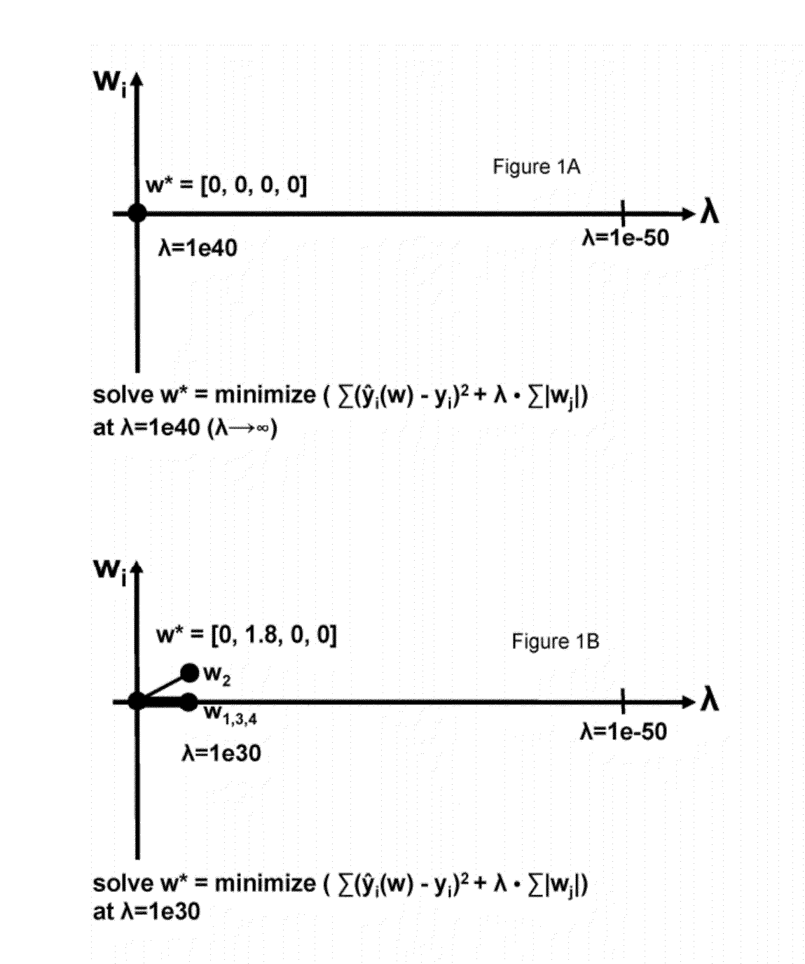

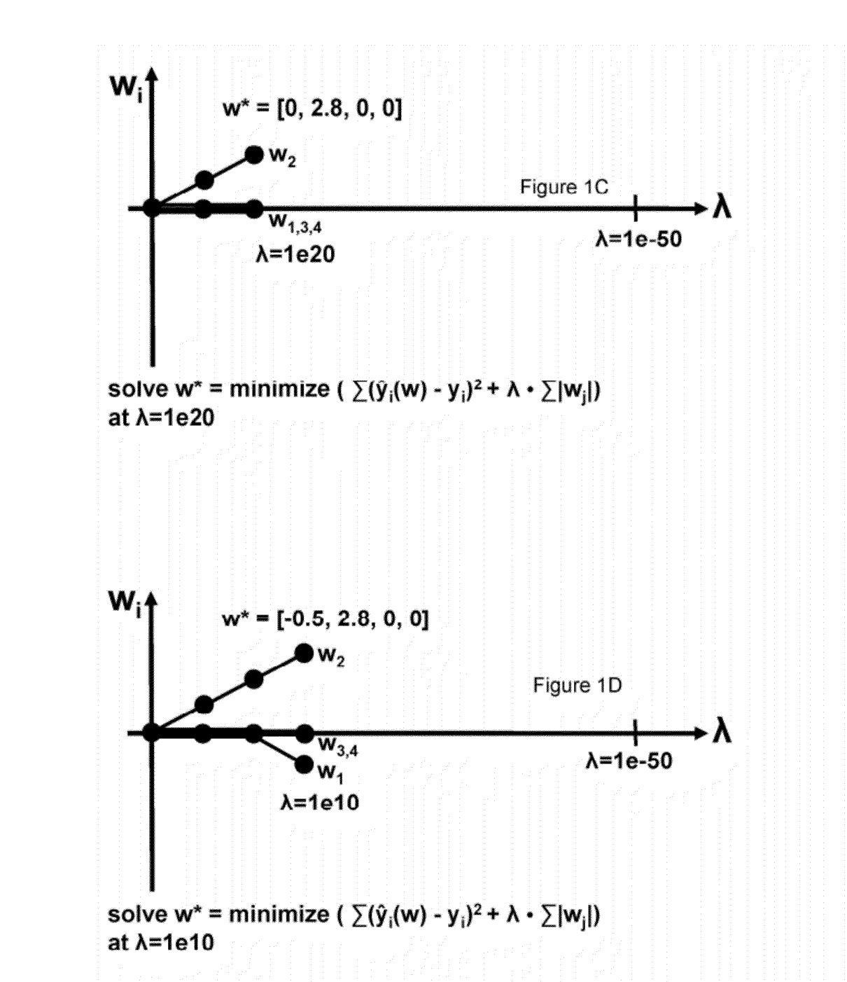

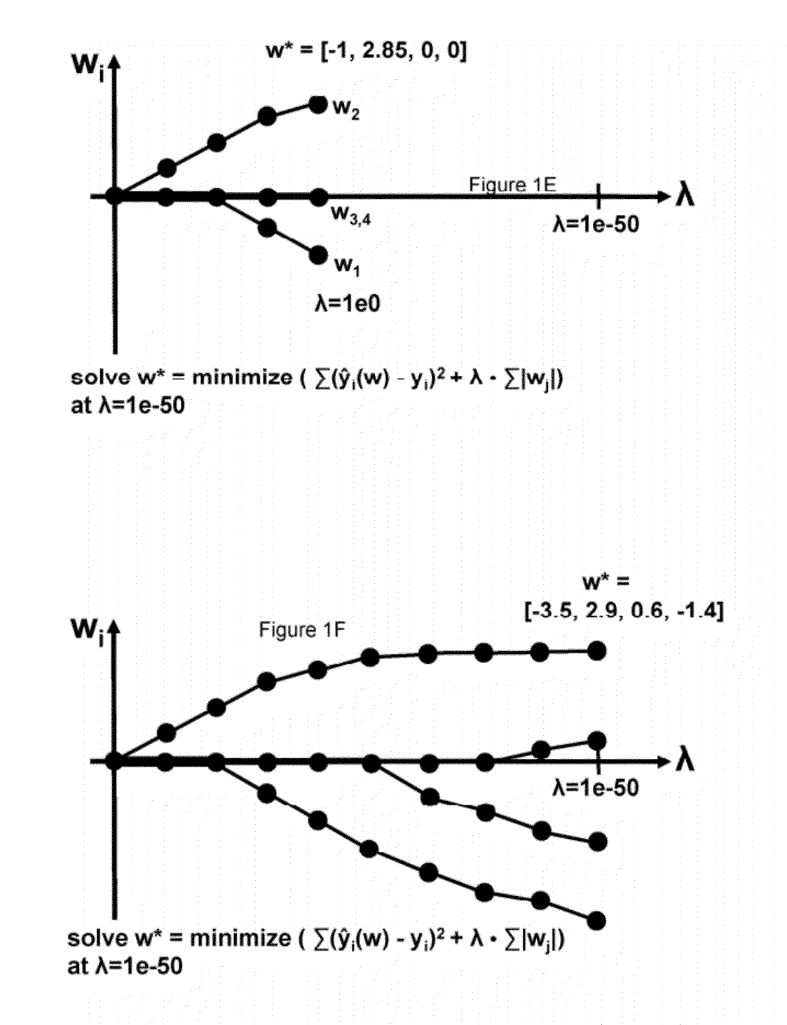

FIGS. 1A-1F demonstrate pathwise regularized regression of equation 3 where λ₂=0 and λ₁ is labeled simply as λ. That is, FIGS. 1A-1F rely on:

$${w}^{*} = Minimize [ {\sum }_{i = 1}^{N} {( {y}_{i} ( x ) - {\hat{y}}_{i} ( x ) )}^{2} + λ {\sum }_{i = 1}^{N} \vert {w}_{i} \vert ] \qquad ( equation 4 )$$

FIGS. 1A-1F show examples of plots of w* as a function of the regularization term λ. FIG. 1A shows an example of a first step of pathwise regularized regression. FIG. 1A show the resulting w* values for λ=1×10⁴⁰ (i.e., λ→∞). In this case, all values of w* are zero. FIG. 1B shows that for λ=1×10³⁰, w* has changed such that w₂=1.8. FIG. 1C shows that for λ=1×10²⁰, w* has again changed and that w₂ now has a value of 2.8. FIG. 1D shows that for λ=1×10¹⁰, w* has changed such that w₁=−0.5 and w₂=1.8. FIG. 1E shows that for λ=1×10⁰ (i.e., λ=1), w* has changed such that w₁=−1.0 and w₂=2.85. Finally, FIG. 1F shows that for λ=1×10⁻⁵⁰, w* has changed such that w₁=−3.5, w₂=2.9, w₃=0.6, and w₄=−1.4. In the graphs of FIGS. 1A-1F, A decreases in the direction indicated by the arrow of the abscissa.

For each decreasing value of λ, the starting value of w* is set to the value obtained with the previous larger value of λ. For example, for λ=1×10²⁰, the starting value of w* was set to the value obtained at λ=1×10³⁰, i.e., w*=[0, 1.8, 0, 0].

Each set of w* defines a model for the performance metric for which the pathwise regularized regression is performed. That is, with respect to any of the FIGS. 1A-1F, each set of vertically aligned w values constitutes a model of the performance metric in question. For example, for λ=1×10³⁰, w*=[0, 1.8, 0, 0] which means that the performance metric model is ŷ(x)=w₀+1.8*B₂(x). Note that offset coefficient, w_{0,} is computed as simply the average value of all training y samples. As another example, for λ=1×10⁻⁵⁰, w*=[−3.5, 2.9, 0.6, −1.4] which means that the performance metric model is ŷ(x)=w₀−3.5*B₁(x)+2.9*B₂(x)+0.6*B₃(x)−1.4*B₄(x). In the example represented at FIGS. 1A-1F, the maximum number of bases was limited to four; however, this need not be the case.

An extremely fast variant of pathwise regularized learning was recently developed/rediscovered: coordinate descent (J. H. Friedman and T. Hastie and R. Tibshirani, “Regularization Paths for Generalized Linear Models via Coordinate Descent”, Journal of Statistical Software, Vol. 33, No. 1, February 2010, pp. 1-22). At each point on the path, coordinate descent solves for coefficient vector w by: looping through each wᵢ one at a time, updating the wᵢ through a trivial formula while holding the rest of the parameters fixed, and repeating until w stabilizes. For speed, it uses “hot starts”: at each new point on the path, coordinate descent starts with the previous point's w.

Pathwise regularized learning has many desirable properties. First, thanks to modern advances, solving a pathwise regularized learning problem is approximately as fast (or faster) than solving a least-squares linear learning problem. Second, because of the regularization term in equation 3, pathwise learning can have more coefficients wᵢ than input variables (or basis functions), unlike least-squares learning. Third, we can remember the information in the path, and use it later; namely, we can consider each step in the path as a different model trading off training error versus complexity (=number of nonzero w's=number of basis functions).

Generally, the present disclosure provides a method to automatically generate functions (models) that map a set of input variables to an output variable (performance metric), for use in scientific/engineering analysis and design. For example, in the field of electrical circuit design, the present disclosure allows to generate models that represent a performance metric of an electrical circuit design as a function of variables of the electrical circuit design. The problem addressed is formulated as follows: Given a set of {x(t),y(t)}, t=1 . . . N data samples where x(t) is a d-dimensional design point t and y(t) is a corresponding circuit performance value (circuit performance metric value) measured from simulation of that electrical circuit design (without any model template), determine a set of symbolic models ŷ(x). that together provide the optimal tradeoff between error and some measure of complexity of the models.

We now summarize two embodiments of the present disclosure, and describe how it takes advantage of the unique properties of pathwise regularized learning.

In one embodiment, a massive set of nonlinear basis functions is generated based on the input variables; then pathwise regularized learning is applied to generate a set of candidate models (of a performance metric) that trade off training error versus complexity; subsequently, the error of the candidate models is measured (calculated) on a separate test dataset. Following this, any models that are not on the optimal tradeoff between testing error and complexity are removed from consideration; and finally, the models that are on the optimal tradeoff between testing error and complexity are stored and/or displayed to the user (designer). Because the present embodiment filters models based on testing error, it overcomes “overfitting” issues commonly encountered in modeling. Regularized learning enables the present disclosure to handle a very large number of input variables, and an even larger number of basis functions. Pathwise learning enables it to generate a whole set of models of different complexities, at the cost of a single linear learning run.

In another embodiment, the present disclosure first identifies the highest-impact univariate basis functions, then applies pathwise learning on combinations of these basis functions. This two-phase approach gives the overall algorithm excellent computational complexity, yet still handles a broad set of bivariate basis functions.

In the following description, for purposes of explanation, numerous details are set forth in order to provide a thorough understanding of the present disclosure. However, it will be apparent to one skilled in the art that these specific details are not required in order to practice the present disclosure. In other instances, well-known electrical structures and circuits are shown in block diagram form in order not to obscure the present disclosure. For example, specific details are not provided as to whether the embodiments of the disclosure described herein are implemented as a software routine, hardware circuit, firmware, or a combination thereof.

The embodiments described herein relate to electrical circuit designs that have associated thereto design variables (device dimensions, resistance, etc.), process variables (statistical variations in gate oxide thickness, substrate doping concentration, etc.), or environmental variables (temperature, load, etc.). The design variables define a design variables space, the process variables define process variables space, and the environmental variables define an environmental variables space. Each point in the design variables space represents a set of values of the design variables for the design in question. Each point in the process variables space represents a set of values of the process variables for the design in question. Each point in the environmental variables space represents a set of values of the environmental variables.

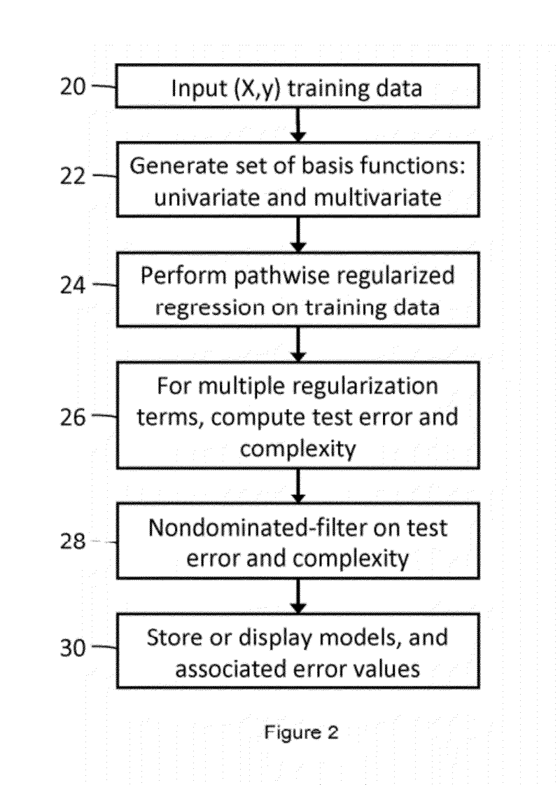

FIG. 2 shows a flow diagram of an embodiment of the present disclosure. At action 20, the training input points X and corresponding outputs y are generated. For example, each training point is a process point (a point in the process variables space), generated via, for example, a Design-of-Experiments (DOE) sampling such as fractional-factorial (D. M. Montgomery, Design of Experiments, 2008); and the output corresponding to that training point is computed as a performance metric value via, for example, a SPICE-like circuit simulation on the process point.

At action 22, a set of univariate and multivariate basis functions is generated. Specifically, each basis function is a function of one input variable xᵢ, such as, for example, log(x₃) or x₅², or more than one input variable, such as, for example, log(x₃)*x₅².

At action 24, a pathwise regularized regression is performed in accordance with the sample paints and in accordance with the performance data (training data). The pathwise regularized regression is performed on a set of basis functions denoted as B={B₁(x), B₂(x), B₃(x), . . . }. Examples of basis functions Bᵢ(x) are provided elsewhere in the present disclosure.

At action 26, the test error of each model obtained as a result of action 24 is calculated. This can be done by sampling the process variables space to obtain test points at which the performance metric of interest is calculate through simulation to obtain a simulated values. The test points are fed to the models obtained as a result of action 24 to obtain modeled values of the performance metric in question. The modeled values are compared to the simulated values for each model, which results in the determination of the testing error.

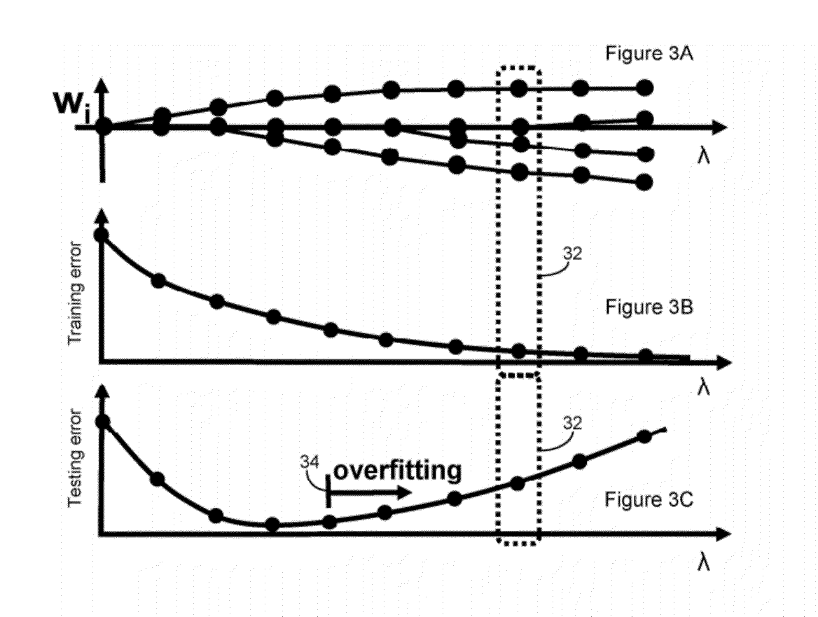

FIG. 3A is a repeat of FIG. 1F. FIG. 3B is aligned below FIG. 3A and shows the training error as a function of λ. The training error is calculated based on the sample points obtained at action 20 of FIG. 2. FIG. 3C is aligned below FIGS. 3A and 3B and shows the test error as a function of λ. The test error is calculated based on the sample points (test points) different than those obtained at action 20 of FIG. 2. In the graphs of FIGS. 3A-3C, λ decreases in the direction indicated by the arrow of the abscissa.

The training error and the testing error plotted in FIGS. 3B and 3C respectively is calculated for each value of λ as:

Σᵢ[ŷᵢ(w)−yᵢ]² (equation 5).

This corresponds to the training error when calculated based on the sample points obtained at action 20, and corresponds to the testing error when calculated based on the test points, which are different than those obtained at action 20 of FIG. 2. As will be understood by the skilled worker, the values obtained through equation 5 can be normalized in accordance with the number points over which the summation takes place.

The vertically-extending dash-lined boxes 32 in FIGS. 3A-3B show weights, testing error and training error for one of the models obtained as a result of the pathwise regularized regression performed at action 24 of FIG. 2. The vertical line 34 in FIG. 3B indicates the value of λ below which over-fitting occurs. That is, the vertical line 34 indicates the value of λ below which the testing error starts increasing with respect to the testing error calculated for immediately preceding larger value of λ.

Referring again to FIG. 2, the complexity of each model obtained as a result of action 24 is also calculated at action 26. In a simple case, complexity can be equal to the number of non-zero weight values for each model.

The input to action 28 of FIG. 2 is a set of models (obtained as a result of action 24), each with a different measure of complexity and error. Some models will be “dominated” by other models: a model “A” is dominated by model “B” if either (a) model A's error is the same or worse than model B's error, and model A's complexity is worse than model B's complexity, or (b) model A's error is worse than model B's error, and model A's complexity is the same or worse than model B's complexity. Action 28 performs “non-dominated filtering”: that is, it removes all the models that are dominated by other models, leaving just the “non-dominated” models. Non-dominated filtering is known in the art, especially in the multi-objective optimization literature, and can be performed, in the present disclosure, in any suitable way. An example algorithm that uses non-dominated filtering is (K. Deb et al, A fast and elitist multiobjective genetic algorithm: NSGA-II, IEEE Transactions on Evolutionary Computation 6(2), April 2002, pp. 182-197).

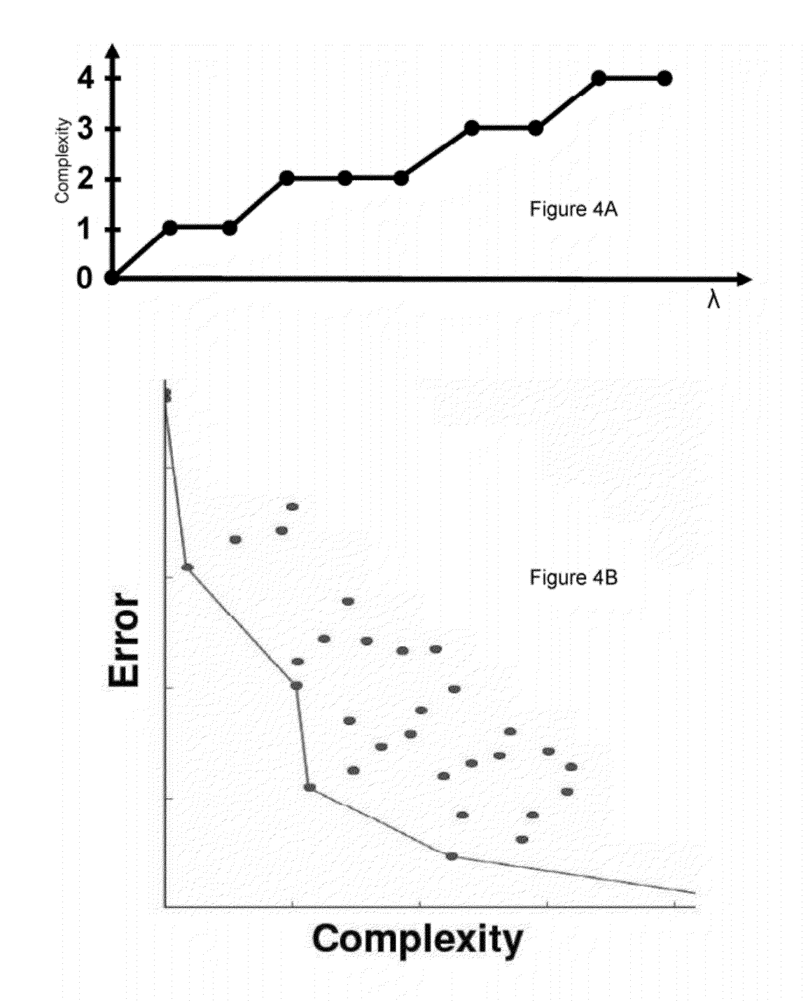

At FIG. 2, action 30, the testing error for each remaining non-dominated model can be plotted (displayed) as a function of the complexity calculated (determined) at action 28. Also, the non-dominated models, and their test error values, can be stored in a tangible, non-transitory computer-readable memory for later use by a designer. FIG. 4A shows complexity as a function of λ for the sets of weights wᵢ (sets of models) shown at FIG. 3A. FIG. 4B shows a plot of test error as a function of complexity for a plurality of models (each point in FIG. 4B represents a model). The points (models) joined by the solid line are non-dominated points (models).

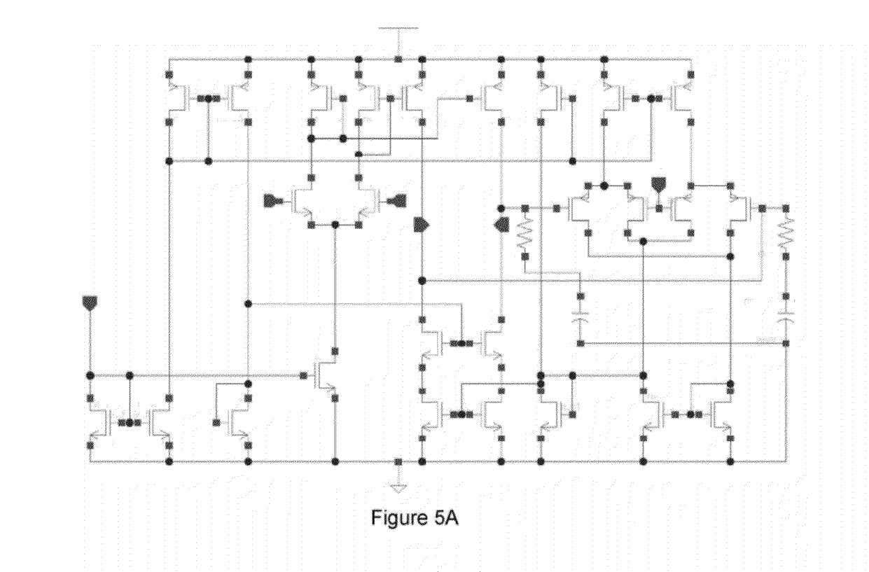

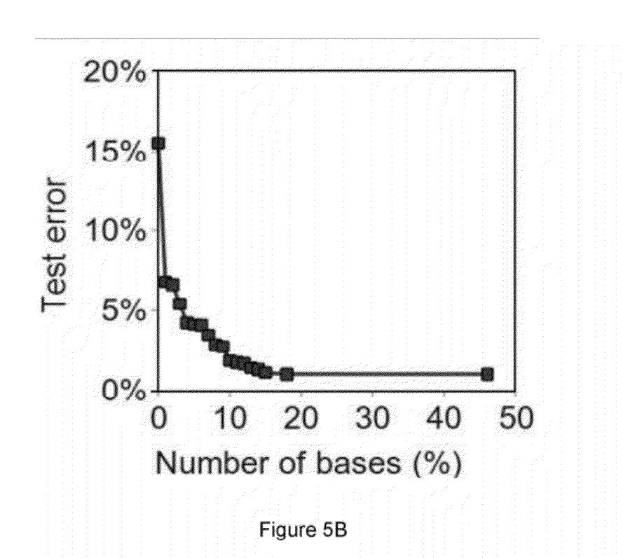

Table I below shows (displays) results relating to an opamp (operational amplifier) whose phase margin (PM) has been modeled in accordance to the flow of FIG. 2. Table 1 has a first column labeled “# of bases”, which is an example measure of complexity; and a second column labeled test error. FIG. 5A shows a circuit diagram of the opamp in question. FIG. 5B shows (displays) a plot of the test error as a function of the number of bases (complexity) for the data of Table I.

TABLE I

| # | Test |
|---|---|
| bases | error |
| 0 | 15.5% |
| 1 | 6.8 |
| 2 | 6.6 |
| 3 | 5.4 |
| 4 | 4.2 |
| 5 | 4.1 |
| . . . | . . . |
| 46 | 1.0 |

Table II below shows an example relating to the same opamp PM data presented at Table I and at FIG. 5B. Table II has a first column showing test error values, and a second column showing the models (PM models in this example) to which the test error values correspond. The input variables are dxl, cgop, dvthn, and dvthp, which refer to different process variations that affect the circuit.

TABLE II

| Test | |
|---|---|
| error | Extracted Equation |
| 15.5% | 59.6 |
| 6.8 | 59.6 − 0.303 · dxl |
| 6.6 | 59.6 − 0.308 · dxl − 0.00460 · cgop |
| 5.4 | 59.6 − 0.332 · dxl − 0.0268 · cgop + 0.0215 · |
| | dvthn |
| 4.2 | 59.6 − 0.353 · dxl − 0.0457 · cgop + 0.0211 · |
| | dvthn − 0.0211 · dvthp |
| 4.1 | 59.6 − 0.354 · dxl − 0.0460 · cgop + 0.0198 · |
| | dvthn − 0.0217 · dvthp + 0.0135 · abs(dvthn) · |
| | dvthn |
| . . . | |
| 1.0 | 58.9 − 0.136 · dxl + 0.0299 · dvthn − 0.0194 . . . |

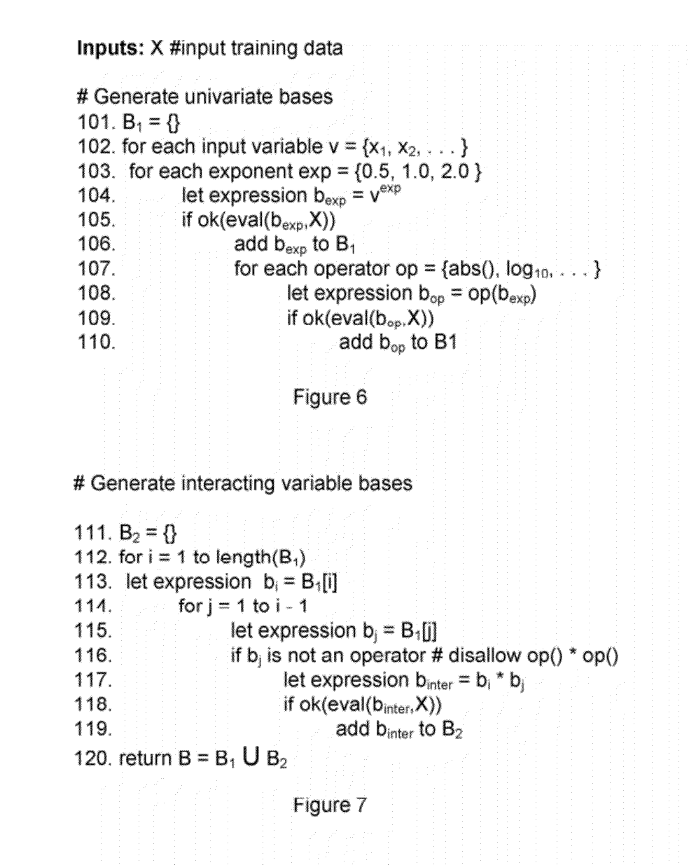

FIG. 6 shows an example of a flow for generating univariate basis functions that can be used in various embodiments of the present disclosure. At action 101, B₁ is defined as a set of univariate basis functions; at action 101, B₁ is an empty set to which basis univariate functions will be added through the iterative actions performed from action 102 through 110. At action 102, a set v is defined and includes all the design variables or environmental variables that can be used to model a performance metric of an electrical circuit design (or any other suitable system). The variables are noted as x₁, x₂, . . . . At action 103, a set of exponents exp is defined. In the present example, the exponent values are 0.5, 1.0, and 2.0. Any other suitable exponent values can be used Without departing from the scope of the present disclosure. At action 104, the expression bₑₓₚ is defined as bₑₓₚ=v^{exp}. At action 105, bₑₓₚ is evaluated at all values of the input training data. If the evaluation of bₑₓₚ returns a valid result, then, at action 106, bₑₓₚ is added to the set B₁.

Subsequently, at action 107, a set of operators op is defined. Examples of operators that can be part of the set op include an absolute value operator abs(xᵢ), a base-10 logarithm log₁₀(xᵢ), and “hinge” functions max(0, xᵢ−thr) and max(0, thr−xᵢ) for different xᵢ and thr values. Hinge functions “turn off” some regions of input space, allowing the model to focus on remaining regions (J. H. Friedman, “Multivariate adaptive regression splines,” Annals of Statistics, vol. 19, no. 1, pp. 1-141, 1991).

At action 108, the expression bₒₚ is defined as bₒₚ=op(bₑₓₚ). Following this, at action 109, bₒₚ is evaluated at all values of the input training data. If the evaluation of bₒₚ returns a valid result, then, at action 110, bₒₚ is added to the set B₁.

In accordance with the present disclosure, FIG. 7 shows a flow diagram for generating multivariate basis functions that can be combined with a set of univariate functions. To start off, the flow of FIG. 7 uses a set of univariate basis functions, for example, the set B₁ determined as per the flow of FIG. 6. Referring again to FIG. 7, at action 111, B₂ is defined as a set of multivariate basis functions; B₂ is an empty set to which basis functions will be added through the iterative actions performed from action 112 through 119.

At action 112, the number of basis functions in the set B₁ is determined; that is, the operation length(B₁) is performed, and an index i range from 1 to length(B₁) is set. At actions 113 to 117, bivariate basis functions are defined as the product of univariate basis functions of the set B₁. The bivariate operators are noted as Bᵢₙₜₑᵣ at action 117.

Following this, at action 118, bᵢₙₜₑᵣ is evaluated at all values of the input training data represented by X. If the evaluation of bᵢₙₜₑᵣ returns a valid result, then, at action 110, bᵢₙₜₑᵣ is added to the set B₂.

Finally, a union operation of the set B₁ with the set B₂ is performed to generate the set of basis function B, which includes the basis function of B₁ and of B₂.

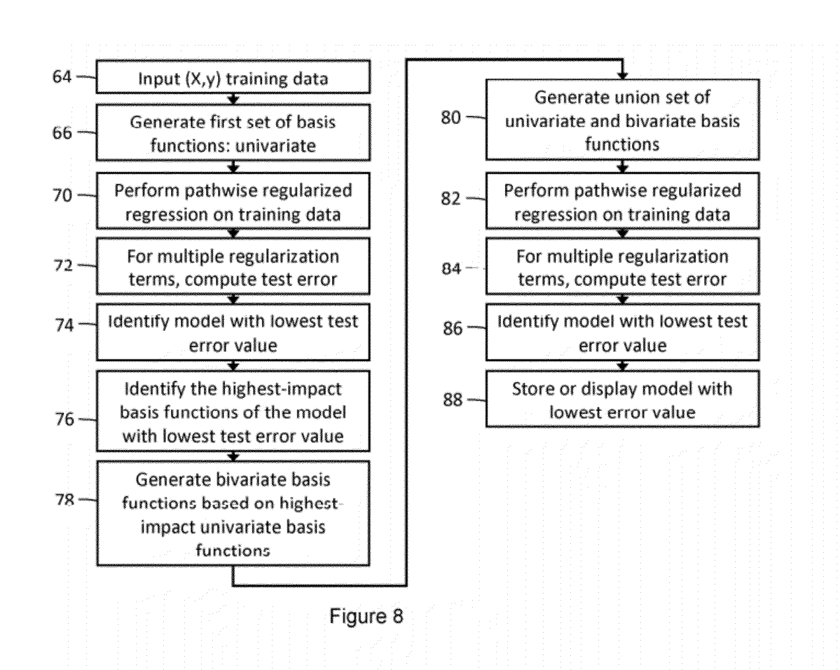

FIG. 8 shows a flow diagram of another embodiment of the present disclosure. At action 64, the training input points X and corresponding outputs y are generated. For example, each training point is a process point, generated via Design-of-Experiments sampling, and the output value is computed via a SPICE or SPICE-like circuit simulation.

At action 66, a set of univariate basis functions is generated. The univariate basis functions can be generated as per the flow of FIG. 6.

At action 70, a pathwise regularized regression is performed in accordance with the sample points X and in accordance with the performance data y. The pathwise regularized regression is performed on the set of univariate basis functions generated at action 66. Alternatively, other types of regularized learning can be performed, such as the lasso or ridge regression.

At action 72, the test error of each model obtained as a result of action 70 is calculated. This can be done by sampling the process variables space to obtain test points at which the performance metric of interest is calculated, through simulation, to obtain simulated values. The test points are fed to the models obtained as a result of action 70 to obtain modeled values of the performance metric in question. The modeled values are compared to the simulated values for each model, which results in the determination of the testing error.

Subsequently, at action 74, the model having the lowest test error is determined by comparing the test error of the models obtained as a result of action 70. Then at action 76, from the lowest-error model, the basis functions (univariate basis functions in the present example) having the highest impact are identified. Some or all of the basis functions with nonzero coefficients may be selected. The motivation to select fewer basis functions is reduce the number of bivariate basis functions generated in the next step, which in turn reduces the overall computational complexity of the algorithm. The impact of each basis function may be computed simply using the absolute value of the basis function's coefficient, or by a more advanced method such as “global nonlinear sensitivity analysis” (T. McConaghy et al, Automated Extraction of Expert Knowledge in Analog Topology Selection and Sizing, Proc. International Conference on Computer-Aided Design, 2008, section 3.1).

At action 78, a set of bivariate basis functions can be generated as per actions 111 to 119 of the flow diagram of FIG. 7 but with the univariate basis functions set B₁{} containing only the basis functions identified at action 76. At action 80, a union set of the univariate basis functions, identified at action 76, and of the bivariate basis functions, generated at action 78, is formed.

At action 82, a pathwise regularized regression is performed in accordance with the sample points and in accordance with the performance data. The pathwise regularized regression is performed on the union set of univariate basis functions and multivariate basis functions formed at action 80.

Subsequently, at action 84, the testing error of the models obtained as a result of action 82 is calculated. At action 86, the model having the lowest test error is identified, and at action 88 it is stored for later user and/or displayed. As an alternative to actions 84 and 86, the models are non-dominated filtered according to test error and complexity, then stored for future use and/or displayed with their associated testing error values or complexity values.

As will be understood by the skilled worker, the flow of FIG. 8 greatly reduces the computational complexity, by applying learning to just a subset of all possible bivariate basis functions. Let us set n as the number of input variables, and N as the number of sample training points. As used in FIG. 8, and as per the flow of FIG. 6, there are “order n” O(n) univariate basis functions. If all two-variable combinations of univariate basis functions were made, that would lead to O(n²) bivariate bases. As is known in the art, pathwise learning has O(N*p²) computational complexity on p basis functions; since there are p=O(n²) bases, then pathwise learning would have O(N*n⁴) computational complexity if all two-variable combinations were used. In contrast, the flow of FIG. 8, in the case where the number of basis functions determined at action 76 is O(√n), has a computational complexity O(N*n²) scaling because O(√n) basis functions combine to make O(n) bivariate basis functions rather than O(n²) bivariate basis functions. This improved computational complexity is what allows the flow of FIG. 8 to scale to higher input dimensions.

As will be understood by the skilled worker, the various pathwise regularized regression actions of the embodiments presented herein can have associated thereto a stop criteria which causes the pathwise regularized regression action to stop once a pre-determined number of non-zero coefficients wᵢ are determined. The predetermined number can be governed by the maximum number of bases that a human wishes to interpret; this number can between 3 and 250).

As shown above, the present disclosure provides a tool for performing symbolic modeling that is more open-ended than the prior art posynomial approach, and has the flexibility of SPICE simulations therefore allowing modeling of any nonlinear circuits.

Further, the present disclosure provides a tool that has reduced computational effort compared to genetic programming approaches, because it does not need to repeatedly evaluate a population of evaluate candidate functions over several generations.

Furthermore, the present disclosure enables the generation of performance metric models that have a good prediction performance, even when the input dimensionality is high or the number of samples is low. This is unlike genetic programming approaches.

Additionally, the flows of the present disclosure are deterministic in nature, so that results are the same run to run, and behavior is easier to predict.

Moreover, the tools of the present disclosure offers a combination of fast runtime and deterministic behavior, which makes them much easier users to adopt.

Finally, the present disclosure provides a means to provide a set of models, which trade between accuracy and complexity.

The present disclosure applies to fields that have use for high-dimensional regression, or fields that have use for symbolic modeling. In high-dimensional regression, the user has a set of high-dimensional input vectors X, a corresponding set output values y, and one wishes to build a regression model that approximates the mapping from X to y, and subsequently use that model. In symbolic modeling, the task is like regression, except the user would also like to be able to inspect the model(s) that are output, and ideally there is a tradeoff between model complexity and prediction error.

Specific fields that have use for high-dimensional regression, or symbolic modeling, include but are not limited to: electronic circuit design to build models that map design, environmental, and process variables to circuit performances such as gain; behavioral modeling of electronic circuits where one aims to approximate the state-transition dynamics with models (current state mapping to next state); design and behavioral modeling in other engineering disciplines; chemical processing, where one replaces expensive sensors with cheap sensors and a model mapping the cheap sensor inputs to a merged sensor value, for an overall system that gives the same fidelity as expensive sensors but at a lower overall cost; scientific exploration and discovery; web search where a regression model is used to give an overall rating to each page, so that pages can be subsequently ranked and presented in rank order; model-building optimization where the model is used as a surrogate for the true objective function; and more.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform actions in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope.

1. A tangible, non-transitory computer-readable medium having stored thereon instructions to be carried out by a computer to perform a method to model a performance metric of a system as a function of variables of the system, the method comprising:
in accordance with a set of sample points of a space defined by the variables of the system, calculating a value of the performance metric for each point of the set of sample points, the values of the performance metric defining performance data;
in accordance with the set of sample points and in accordance with the performance data, performing, on a set of basis functions, each basis function having associated thereto a weight factor, a pathwise regularized linear regression algorithm having associated thereto a regularization term, to obtain multiple models of the performance metric of the system at respective multiple values of the regularization term, each model having a set of weight factors values, each value of the regularization term having associated thereto a single model of the performance metric;
for a plurality of regularization term values, calculating an error value and a complexity value of a corresponding model of the performance metric; and
for the plurality of regularization term values, performing a non-dominated filtering of the models corresponding to the plurality of regularization term values, the non-dominated filtering being performed in accordance with the error value and the complexity value of each model, the non-dominated filtering to obtain non-dominated models of the performance metric.

2. The tangible, non-transitory computer-readable medium of claim 1 further comprising a step of storing, on a tangible non-transitory computer-readable memory, the non-dominated models.

3. The tangible, non-transitory computer-readable medium of claim 1 further comprising a step of displaying the non-dominated models and their respective error values.

4. The tangible, non-transitory computer-readable medium of claim 1 wherein the set of sampling points is extracted from the space defined by the system variables.

5. The tangible, non-transitory computer-readable medium of claim 1 wherein the set of sampling points is generated from the space defined by the system variables.

6. The tangible, non-transitory computer-readable medium of claim 5 wherein the set of sampling points is generated through a design-of-experiments technique.

7. The tangible, non-transitory computer-readable medium of claim 1 wherein the system variables are design variables and the space defined by the variables of the system is a design variables space.

8. The tangible, non-transitory computer-readable medium of claim 1 wherein the system variables are process variables and the space defined by the variables of the system is a process variables space.

9. The tangible, non-transitory computer-readable medium of claim 1 wherein the system variables are environmental variables and the space defined by the variables of the system is an environmental variables space.

10. The tangible, non-transitory computer-readable medium of claim 1 wherein the complexity of a model of the performance metric is equal to the number of basis functions of the model of the performance metric.

11. The tangible, non-transitory computer-readable medium of claim 1 further comprising:
extracting sample points from the space defined by the variables, to obtain test sample points, wherein calculating the error value is carried out at the test sample points.

12. A tangible, non-transitory computer-readable medium having stored thereon instructions to be carried out by a computer to perform a method to model a performance metric of a system as a function of variables of the system, the method comprising:
in accordance with a set of sample points of a space defined by the variables of the system, calculating a value of the performance metric for each point of the set of sample points, the values of the performance metric defining performance data;
generating a first set of basis functions consisting of univariate basis functions;
in accordance with the set of sample points and in accordance with the performance data, performing, on the set of univariate basis functions, each univariate basis function having associated thereto a weight factor, a pathwise regularized linear regression algorithm having associated thereto a first regularization term, to obtain multiple models of the performance metric of the system at multiple values of the first regularization term, each model having a respective set of weight factors values, each value of the first regularization term having associated thereto a single model of the performance metric;
identifying a model having a lowest test error to obtain an identified model;
identifying the univariate basis functions of the identified model that have the highest impacts, to obtain identified univariate basis functions;
in accordance with the identified univariate basis functions, generating a set of bivariate basis functions;
generating a union set of basis functions comprising the identified univariate basis functions and the set of bivariate basis functions;
in accordance with the first set of sample points and in accordance with the performance data, performing, on the union set of basis functions, each basis function having associated thereto a weight factor, a pathwise regularized linear regression algorithm having associated thereto a second regularization term, to obtain multiple models of the performance metric of the system at multiple values of the second regularization term, each model having a respective set of weight factors values, each value of the second regularization term having associated thereto a single model of the performance metric; and
for a plurality of second regularization term values, calculating an error value of a corresponding model of the performance metric.

13. The tangible, non-transitory computer-readable medium of claim 12 further comprising:
identifying the model of the performance metric having a lowest error value to obtain a lowest error model of the performance metric; and
storing the lowest error model of the performance metric on a tangible, computer-readable memory.

14. The tangible, non-transitory computer-readable medium of claim 12 further comprising:
identifying the model of the performance metric having a lowest error value to obtain a lowest error model of the performance metric; and
displaying the lowest error model of the performance metric and the error value of the lowest error model of the performance metric.

15. A tangible, non-transitory computer-readable medium having stored thereon instructions to be carried out by a computer to perform a method to model a performance metric of a system as a function of variables of the system, the method comprising:
in accordance with a set of sample points of a space defined by the variables of the system, calculating a value of the performance metric for each point of the set of sample points, the values of the performance metric defining performance data;
generating a first set of basis functions consisting of univariate basis functions;
in accordance with the set of sample points and in accordance with the performance data, performing, on the set of univariate basis functions, each univariate basis function having associated thereto a weight factor, a pathwise regularized linear regression algorithm having associated thereto a first regularization term, to obtain multiple models of the performance metric of the system at multiple values of the first regularization term, each model having a respective set of weight factors values, each value of the first regularization term having associated thereto a single model of the performance metric;
identifying a model having a lowest test error to obtain an identified model;
identifying the univariate basis functions of the identified model that have the highest impacts to obtain identified univariate basis functions;
in accordance with the identified univariate basis functions, generating a set of bivariate basis functions;
generating a union set of basis functions comprising the identified univariate basis functions and the set of bivariate basis functions;
in accordance with the first set of sample points and in accordance with the performance data, performing, on the union set of basis functions, each basis function having associated thereto a weight factor, a pathwise regularized linear regression algorithm having associated thereto a second regularization term, to obtain multiple models of the performance metric of the system at multiple values of the second regularization term, each model having a respective set of weight factors values, each value of the second regularization term having associated thereto a single model of the performance metric;
for a plurality of second regularization term values, calculating an error value and a complexity value of a corresponding model of the performance metric; and
for the plurality of second regularization term values, performing a non-dominated filtering of the models corresponding to the plurality of second regularization term values, the non-dominated filtering being performed in accordance with the error value and the complexity value of each model, the non-dominated filtering to obtain non-dominated models of the performance metric.

16. The tangible, non-transitory computer-readable medium of claim 15 further comprising a step of storing, on a tangible non-transitory computer-readable memory, the non-dominated models.

17. The tangible, non-transitory computer-readable medium of claim 15 further comprising a step of displaying the non-dominated models and their respective error values.

18. The tangible, non-transitory computer-readable medium of claim 15 wherein the set of sampling points is extracted from the space defined by the system variables.

19. The tangible, non-transitory computer-readable medium of claim 1 wherein the set of sampling points is generated from the space defined by the system variables.

20. The tangible, non-transitory computer-readable medium of claim 5 wherein the set of sampling points is generated through a design-of-experiments technique.
